(19) United States
(12) Patent Application Publication
(10) Pub. No.: US 2002/0175286 A1
(43) Pub. Date: Nov. 28, 2002

(54) Uncooled LWIR hyperspectral imager

(76) Inventor: James E. Murguia, Hollis, NH (US)

Correspondence Address: James E. Murguia, 27 Wright Road, Hollis, NH, 03049, US

(21) Appl. No.: 09/808,961

(22) Filed: Mar. 16, 2001

(51) Int. Cl. G01J 5/02

(52) U.S. Cl. 250/339.07; 250/339.02

(57) ABSTRACT

Tomographic approaches to hyperspectral imaging, such as CTHIS¹³ (Chromotomographic Hyperspectral Imaging Sensor), can eliminate the need for the slit, filter, or resonant cavity and substantially increase the optical throughput of the system. These systems capture most of the photon energy from the entire spectral band over the entire measurement interval. Uncooled LWIR imaging technology uses thermal based detecting elements that are less sensitive than the competing photon based cooled detecting elements, and require high optical throughput. An uncooled LWIR hyperspectral imager is described that combines a new high optical efficiency spectral imaging technique combined with a high performance uncooled thermal imager. The merging of these technologies in the current invention will significantly reduce the size, weight, and power requirements of LWIR hyperspectral systems.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Field of Invention

The present invention generally relates to spectral imaging, and in particular, the present invention relates to a method for spectral imaging in the 8-14 μm Long Wavelength InfraRed (LWIR) without the need for cooling or refrigeration.

2. Description of Related Art

Spectral imagers sense radiation intensity both spatially and spectrally. Typical hyperspectral imagers either scan a slit across the scene 10, iterate through a sequence of narrow band filters 11, or move an interferometer mirror to construct the image 11, as shown in FIG. 1. To obtain high spectral resolution, the slit is made thin, the filter is made narrow, or the finesse is made high; however, these restrictions limit the amount of light passed by the optical system. In general, the performance of a hyperspectral imager is limited by the optical throughput. The low optical throughput of most hyperspectral optical systems compounds the sensing problem for the detector array, and makes the use of all but the highest performance arrays impractical.

Photon detectors operating in the LWIR require refrigerators capable of maintaining a 10K-80K ambient for the focal plane array as well as the optics. A new class of thermal LWIR detectors operates at room temperature, however, the sensing mechanism of these detectors is incompatible with the limited optical throughput of scanned slit or filter based spectral imagers. Future uncooled detectors, having improved thermal isolation, may be able to support scanned and filter based imagers.

Uncooled LWIR imaging technology uses temperature detecting elements that are less sensitive than the competing photon based cooled detecting elements. The uncooled sensor focal plane consists of an array of thermally isolated thermal detectors that are heated by an incident infrared image. These sensors are low cost, compact and rugged, but require higher optical signal levels than photon detectors.

Conventional approaches to hyperspectral imaging cannot currently use uncooled LWIR imaging technology because the light passing through the optical system is not sufficient to heat the thermally sensitive imaging elements above the thermal noise. Consequently, no uncooled LWIR hyperspectral imagers have been reduced to practice. However, the signal throughput of the recently developed chromotomographic hyperspectral imaging sensor is sufficiently high to overcome this technological barrier.

### BRIEF SUMMARY OF INVENTION

FIG. 2 is a schematic representation of a ChromoTomographic Hyperspectral Imaging Sensor, CTHIS, consisting of a telescope 20, a field stop 21, a direct vision prism 22, a focus lens 23, and a focal plane array 24.

A direct vision prism consists of two prisms that are arranged such that one wavelength passes undeviated, while the other wavelengths are dispersed along a line. The direct vision prism is mounted on a bearing so that it can be rotated around the optical axis. As the prism is rotated, the spectral features trace out circles with wavelength dependent radii. The projected image is dispersed on the focal plane array. Computational methods are used to reconstruct the scene as a three-dimensional spectral image, or “data cube.” The approach is tomographic, and similar to the limited-angle tomography techniques used in medicine.

In the CTHIS tomographic system, all photons that pass through the sensor field stop, are imaged onto the focal plane 12. This continues for a full integration time, wherein the prism rotates 360 degrees. This super-integration requires a de-multiplexing operation to extract the spectral imagery from the measured data. As an added benefit, the mathematical reconstruction in chromotomography simultaneously returns the data cube and the principal components of the spectral image.

The uncooled sensor focal plane consists of an array of thermally isolated microbolometer detectors, which are heated by an incident infrared image. These sensors are low cost, compact and rugged, but require higher optical signal levels than are available from conventional hyperspectral instruments.

It is thus an objective of the present invention to utilize the high optical throughput of the CTHIS sensor to provide the increased signal levels needed for uncooled sensor operation.

It is thus a further objective of the present invention to provide an LWIR spectral imager architecture that does not require a refrigerator.

### BRIEF DESCRIPTION OF THE SEVERAL VIEWS OF THE DRAWING

The above and other features and advantages of the present invention will become readily apparent from the description that follows, with references to the accompanying drawings, in which:

FIG. 1 illustrates a comparison of hypercube signal acquisition by scanned slit 10, filter wheel (or interferometer) 11, and CTHIS tomographic hyperspectral 12 imagers.

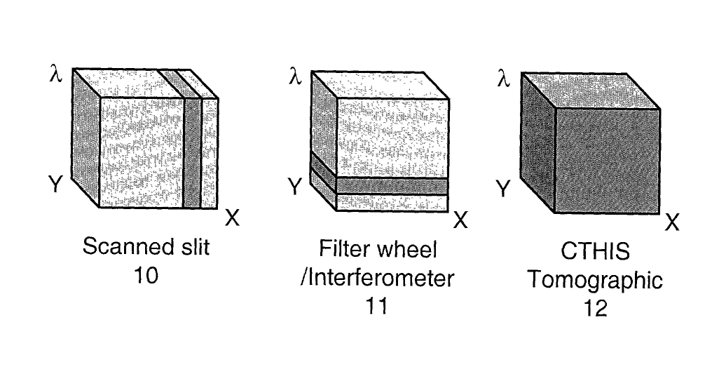

FIG. 2 illustrates a schematic representation of a chromotomographic spectral imager. The direct view prism or grating 22 is shown spreading red, green, and blue light across the focal plane array 24.

### DETAILED DESCRIPTION OF THE INVENTION

Hyperspectral imagers quantify the spatial and spectral characteristics of a scene; typically using a scanned slit 10, filter wheel or interferometer 11. These instruments operate by dispersing the light from a slit image over a two-dimensional focal-plane-array, the spectrum of a slit of pixels is measured, the slit is advanced by one slit width, and then the spectrum of the next slit of pixels is measured. Alternatively, the instrument iterates through a sequence of narrow band filters, or moves an interferometer mirror. To obtain high spectral resolution, the slit is made thin, the filter is made narrow, or the finesse is made high. However, a thin slit, narrow filter, or high finesse cavity limit the amount of light passed by the optical system, reducing the signal to noise ratio of the image. In general, the performance of these hyperspectral imagers is limited by the poor optical throughput of the slit (the AΩ product). Nevertheless, slit instruments provide the baseline against which all other instruments are compared.

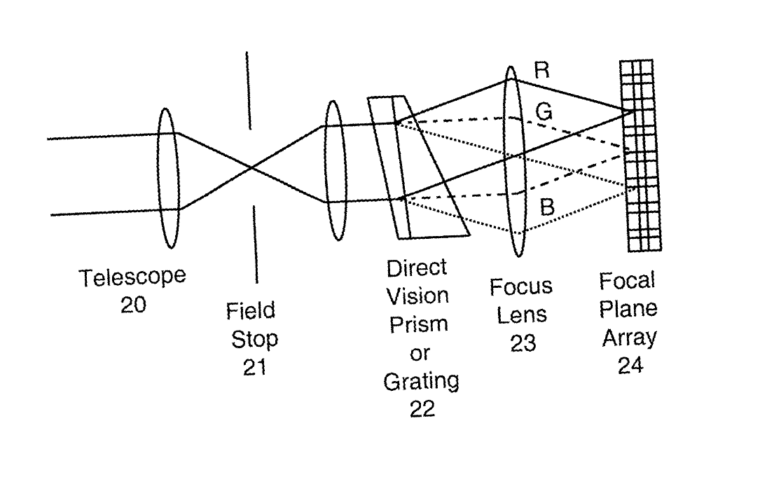

FIG. 2 is a schematic representation of a chromotomographic hyperspectral imaging sensor, consisting of a telescope 20, a field stop 21, a direct vision prism 22, a focus lens 23, and a focal plane array 24. A direct vision prism consists of two prisms that are arranged such that one wavelength passes undeviated, while the other wavelengths are dispersed along a line, or dispersion axis. An image projected onto the focal plane will be dispersed along this axis. The direct vision prism is mounted on a bearing so that it can be rotated on the optical axis of the telescope. During the measurement of successive video frames, the dispersion axis is rotated, causing the image of spectral features to trace out circles with wavelength dependent radii. This has the effect of multiplexing the color information of the image over the array, which, otherwise, is operating as a broad band polychromatic sensor. Tomographic computational methods that are similar to the limited-angle tomography techniques used in medicine are used to reconstruct the scene.

The sensor tomographic technique can be summarized as follows. During a video frame, all photons from the observed scene, which pass through the field stop, are detected by the focal plane array 12. This includes all photons within the spectral response range of the detector. During successive frames, the rotating prism multiplexes spectral features over the focal plane array. Video frames are collected over a full prism rotation. This super-integration requires a de-multiplexing operation to extract the spectral imagery from the measured data. As an added benefit, the mathematical chromotomographic reconstruction simultaneously returns the data cube and the principal components of the spectral image.

As the preferred embodiment, I describe the reconstruction algorithm for the prism dispersion following Brodzik and Mooney,¹ and the LWIR thermionic thermal detector for the FPA following Murguia et al.²

Reconstruction Algorithm

A chromotomographic hyperspectral imaging spectrometer reconstructs a three dimensional spatial-chromatic scene from a sequence of two-dimensional images. The generic pseudo-inverse reconstruction algorithm is described in this section; however, the reconstruction can be accomplished using various approaches that depend on the constraints applied to the solution, and the level of fidelity required. FIG. 2 describes the physical implementation of this computed-tomography image spectrometry approach. In this approach, a rotating prism accomplishes the multiplexing. As the prism rotates, each chromatic slice of the object cube follows a circular path with the radius of the path determined by the prism dispersion. A sequence of spatial tomographic projections g(\overline{x}, φ) is thus obtained, each tomographic projection being an integral of the three-dimensional spatial-chromatic object cube f(\overline{x}, λ) in the chromatic variable λ.

$$g ( \overline{x} , φ ) = {\int }_{- ∞}^{+ ∞} f ( \overline{x} - k ( λ - {λ}_{0} ) {\overline{p}}_{φ} , λ ) ⅆ λ , \qquad ( 1 )$$

where \overline{x}=(x₁,x₂), \overline{p}₁₀₀ =(cosφ,sinφ), 0<φ<2π, λ₀ is the center wavelength, and k is a spectrometer constant determined by the sensor focal length and prism dispersion. The mathematics of sampling the object cube f(\overline{x}, λ) to get the projection g(\overline{x}, λ) is described below. This operation can be recognized as a three-dimensional x-ray transform of f(\overline{x}, λ), with integration performed over a line in direction k\overline{p}₁₀₀ , where k determines the angle between the integration line and the optical axis. Taking the two-dimensional Fourier transform of Equation 1 in the spatial variable \overline{x}, we have,

$$g ( \overline{ξ} , φ ) = {\int }_{- ∞}^{+ ∞} {ⅇ}^{- 2 π i < k {p}_{φ} , \overline{ξ} > ( λ - {λ}_{0} )} f ( \overline{ξ} , λ - {λ}_{0} ) ⅆ λ , \qquad ( 2 )$$

where f(\overline{ξ}, λ) is the two-dimensional Fourier transform of f(\overline{x},λ) in \overline{x}, and \overline{ξ}=(ξ₁,ξ₂) is the frequency variable.

Consider a version of Equation 2, sampled at discrete chromatic bands and discrete angles,

$${g}_{m} ( \overline{ξ} , φ ) = {\sum }_{n = 0}^{N - 1} {ⅇ}^{- 2 π i < {\overline{p}}_{m} , \overline{ξ} > ( n - {n}_{0} )} {f}_{η} ( \overline{ξ} ) , \qquad ( 3 )$$

where

$${\overline{p}}_{m} = ( cos \frac{2 π m}{M} , sin \frac{2 π m}{M} ) ,$$

0≦m<M, M≧N, n=kλ, n₀=kλ₀, so we have

$$[ \begin{matrix}{g}_{0} ( \overline{ξ} ) \\ {g}_{1} ( ξ ) \\ ⋮ \\ {g}_{M - 1} ( \overline{ξ} )\end{matrix} ] = A ( \overline{ξ} ) [ \begin{matrix}{f}_{0} ( \overline{ξ} ) \\ {f}_{1} ( ξ ) \\ ⋮ \\ {f}_{N - 1} ( \overline{ξ} )\end{matrix} ] \qquad ( 4 )$$

where the A(\overline{ξ}) is an M×N matrix with elements

A_{m,n}(\overline{ξ})=e^{-2πi<\overline{p}}^{_{m,}}^{\overline{ξ}>(n-n}^{₀}). (5)

Equation 5 can be expressed as

g=AF. (6)

The existence and uniqueness of the solution of Equation 6 depends on the rank of A, which is equal to the number of independent rows of A. Equation 5 shows that A is ill-conditioned for many values of \overline{ξ}. A convenient tool for evaluating the rank of a matrix is singular value decomposition (SVD). The singlar value decomposition of a matrix A is defined as³

A=UΣV^{H}, (7)

where U and V are M×N and N×N matrices, such that,

U^{H}U=VV^{H}=V^{H}V=I, (8)

The superscript H indicates Hermitian adjoint, and Σ is an N×N diagonal matrix of singular values,

Σ=diag(σ₀,σ₁, . . . ,σ_{N-1}), (9)

such that σ₀≧σ₁ . . . ≧₁₃ σ_{N-1}≧0. If A is non-singular, i.e. σ₀≧σ₁≧. . . ≧_σ_{N-1}≧0, then a matrix inverse of A can be computed as

A⁻¹=VΣ⁻¹U^{H}, (10)

where elements of Σ⁻¹ are found by inverting elements of Σ, and Equation 6 has a unique solution given by

f=A⁻¹g. (11)

If A is singular, i.e. there is K<N such that σ₀ ≧. . . ≧_σ_{K-1}>σ_{K}=. . . =σ_{N-1}=0,

Σ=Σₖ=diag(σ0, . . . , , σ_{K-1}, 0 , . . . ,0), (12)

and a direct inverse A⁻¹ cannot be obtained. Thus, Equation 6 cannot be solved uniquely. Alternatively, the Moore-Penrose inverse⁴ (a pseudo-inverse) A⁺ can be used to find a minimum length least square solution of Equation 6. The pseudo-inverse of a matrix A is defined as

A⁺=VΣ⁺U^{H}, (13)

where the diagonal matrix Σ⁺ is formed by replacing non-zero elements of Σ with the reciprocal values

Σ⁺=diag(σ₀⁻¹, . . . σ_{K-1}⁻¹,0 . . . 0). (14)

Multiplying both sides of Equation 6 by A⁺ yields the pseudo-solution

f⁺=A⁺g. (15)

In practice the recorded data g is contaminated by noise, n,

g=Af+n. (16)

In effect, small nonzero singular values of A result in instabilities. These instabilities can be considered by,

A⁺g=A⁺Af+A⁺n=VΣ⁺(ΣV^{H}f+U^{H}n). (17)

If elements of Σ are close to zero, then elements of Σ⁺ become very large and the filtered noise dominates the restoration. In order to balance the loss of spectral resolution and noise amplification due to small singular values, a modified version of Equation 10 can be used, where small singular values close to the noise variance are set to zero. Alternatively, a regularization technique can be applied, which allows for gradual transition of singular values to zero.⁵ Nevertheless, the method of inversion, as implemented by Equation 11, leads to artifacts in the estimate of the hyperspectral image, particularly in scenes with a significant information content in the low spatial/high chromatic frequency regime, which coincides with the null space of A. To improve fidelity of the hyperspectral image, one needs to recover the null space information. This recovery of information can be done by using a priori information about the scene, such as finite extent, finite intensity range, energy bounds, etc., in the form of solution constraints. If the pseudo-solution does not meet these constraints, repetitive application of a sequence of constraints to the estimate leads to recovery of the null space information and to reduction of artifacts. These techniques are described in further detail in Brodzik and Mooney.¹

Thermionic Thermal Detector

The preferred embodiment of the present invention is based on the utilization of a thermionic thermal detector array, or “Schottky bolometer” array. However, the thermal imaging function of the sensor could also be provided by alternative uncooled focal plane arrays, based on pyroelectric, ferro-electric, semiconductor or metallic temperature detecting elements. The Thermionic Thermal Detector (TTD) senses infrared radiation by temperature modulation of thermionic emission current within a silicon Schottky diode. The thermionic emission current is the well known Richardson dark current. The TTD operates in the LWIR band. The physics of TTD operation is distinct from that of silicon Schottky barrier MWIR photo-detectors, such as PtSi/Si which are based on internal photoemission. The TTD detects incident power as manifested in a change of its temperature. The TTD sensing mechanism has high detection efficiency, as opposed to the photodetection process which is limited by conservation of momentum. The architecture of a TTD array is very similar to that of other microbolometer arrays, except the detector elements are thermally isolated Schottky diodes, operating under reverse bias. When the TTD array is illuminated by an infrared image, the temperature of individual detector elements will vary with the local incident power of the image. Under small signal conditions, the dark current of individual detectors will vary as temperature, resulting in an electronic image of the infrared scene.

The reverse bias dark current of a Schottky diode varies exponentially with temperature. For the small temperature variations observed on the focal plane of an uncooled sensor, this variation is approximately linear. The rate of temperature variation is determined by the Schottky barrier potential and, to a lesser extent by the applied bias potential. The operating temperature range of the detector can be designed into the device by selecting a metal with the appropriate Schottky barrier height. Experimental Schottky barrier heights were determined using Richardson dark current activation energy analysis. Devices optimized for operation at room ambient temperature have a 5% K to 6% K temperature coefficient, twice that of competing uncooled detector technologies. The use of Schottky diode thermionic emission for uncooled infrared imaging offers several advantages relative to current technology. TTD manufacture is 100% silicon processing compatible. Schottky barrier based thermionic emission arrays have the same uniformity characteristics as MWIR Schottky barrier photoemissive arrays. Operating TTDs in reverse bias provides a high impedance “current source” to the multiplexer, resulting in negligible Johnson noise. This mode of operation also results in negligible detector 1/f-noise and drift. In addition, the TTD thermionic emission detection process has high efficiency, fully comparable with the best current thermal detectors.

A TTD array employs metal-silicide/silicon Schottky diodes as thermal detectors. The individual Schottky detectors are thermally isolated, similar to current microbolometer technology. The Schottky diodes are operated under reverse bias, to achieve very high impedance and to minimize 1/f-noise. Under these conditions, the diode is dominated by thermionic emission dark current, which varies exponentially with the absolute temperature. For a fixed bias voltage and Schottky barrier height, the magnitude of the reverse bias current gives a direct measure of the absolute temperature of the diode.

The TTD architecture is very similar to that of a VOₓ based microbolometer array. The Schottky barrier thermal detector is suspended on a thermally isolated plate. The diode current flow is perpendicular to the plane of the plate. The plate is heated, for a video frame time, by the local incident power of the image. The detector is electrically isolated and at zero bias. For a short read-out interval the detector is back biased and temperature sampled by measurement of its dark current. This current is compared to the dark current of a reference detector that is not exposed to the LWIR radiation. The difference in the currents is the signal. The diode dark current changes approximately 6% for every 1 C. change in the temperature of the plate. In an f/1 camera system, the radiation from a 1K differential source at 300K, will raise the temperature of the detector plate by 10-20 mK, resulting in 0.1% change in the diode dark current. The sample current must be large enough to produce the required sensitivity, when scaled by the temperature coefficient and temperature rise of the plate. The sample current levels and noise performance of current art microbolometer multiplexer circuits will meet TTD sensor requirements.

Relative to VOₓ based microbolometer arrays, TTD arrays offer improved elemental temperature sensitivity, reduced noise, greater uniformity and better compatibility with silicon integrated circuit manufacturing. Central to the development of the thermionic thermal detector is the maturation of three key microelectronic technologies: the fabrication of high ideality metal-silicide Schottky diodes with several barrier heights,⁶ the micro-machining of thermally isolated silicon microstructure arrays,^{7,8,9} and the availability of high quality SIMOX and BESOI wafers.¹⁰

Thermal Temperature Response

The heat flow from the surface of the detector via radiation follows the Stefan-Boltzmann law,

P_{Rad}=A_{Eff}ε_{D}σT_{D}⁴. (18)

Where A_{Eff} is the effective area of the detector, ε_{D} the emissivity and σ the Stefan-Boltzmann constant. The thermal conductance of the detector due to radiation, G_{Rad}, is given by:¹¹

G_{Rad}=4A_{Eff}ε_{D}σT_{D}³ (19)

In Equation 19, the detector pixel is approximated by a thin flat plate, which radiates in the forward direction and is assumed to be Lambertian. The optical power on a detector is the sum of the signal power and the background power,

$${P}_{D} = {P}_{D S} + {P}_{D B} = \frac{{A}_{Eff} {ϵ}_{D} σ {T}_{S}^{4}}{4 {F}^{2} + 1} + ( 1 - \frac{1}{4 {F}^{2} + 1} ) {A}_{Eff} {ϵ}_{D} σ {T}_{B}^{4} \qquad ( 20 )$$

Equation 20 assumes the signal comes from an extended source at temperature T_{S} and the background radiation from the sensor enclosure at temperature T_{B}.

The emissivity of the background and the source is assumed to be one. Differentiating Equation 20, the change in power on a detector for an incremental change in signal temperature is given by,

$$\frac{ⅆ {P}_{D}}{ⅆ {T}_{S}} = \frac{ⅆ {P}_{D S}}{ⅆ {T}_{S}} = \frac{4 {A}_{Eff} {ϵ}_{D} σ {T}_{S}^{3}}{4 {F}^{2} + 1} . \qquad ( 21 )$$

The incidence of this power causes the detector temperature to rise an amount ΔT_{d}, which is determined by the power balance at the sensing element as:

$$Δ {T}_{d} = \frac{1}{4 {F}^{2} + 1} ( \frac{{G}_{Rad}}{{G}_{Rad} + {G}_{Diff}} ) Δ {T}_{s} \qquad ( 22 )$$

Where G_{diff} represents the thermal conduction loss from the detector element to through its support structure to the focal plane substrate. The thermal conduction loss of a detector element can only be ignored if the radiative heat loss from the detector element is much larger. That is:

G_{Rad}>>G_{Diff} (23)

Under that condition, the sensor becomes background radiation limited and the sensor temperature transfer gain becomes:

$$Δ {T}_{D} = \frac{Δ {T}_{S}}{4 {F}^{2} + 1} . \qquad ( 24 )$$

Most current day thermal sensors are thermal diffusion limited and relationships 23 and 24 do not apply.

Detector Electrical Response

The current density in a Schottky diode based thermal detector is calculated from thermionic emission theory,¹²

J=J_{S}(e^{qV/kT}−1), (25)

where kT is the thermal energy and J_{S} the saturation current density.

When the detector is operated under back bias, at voltages large compared to kT/q, the reverse current density J_{R} reduces to the saturation current density.

J_{R}=J_{S}=A^{**}T²e^{-qφ}^{_{bn}}^{/kT} (26)

Where, qφ_{bn} is the Schottky barrier potential at the operating bias V and A^{**} is the modified Richardson constant.

The change in the reverse current in a thermionic detector as a function of temperature, ∂J_{R}/∂T, is given by:

$$\frac{\partial {J}_{R}}{\partial T} = T ( \frac{q {Φ}_{b n}}{k T} + 2 ) {A}^{**} {ⅇ}^{- q {Φ}_{b n} / kK T} \qquad ( 27 )$$

The resulting TTD temperature coefficient, (1/J_{R})∂J_{R}/∂T, is given by:

$${α}_{T} = \frac{1}{{J}_{R}} \frac{\partial {J}_{R}}{\partial T} = \frac{1}{T} ( \frac{q {Φ}_{bn}}{kT} + 2 ) . \qquad ( 28 )$$

For a TTD with a 0.36 eV Schottky potential, the temperature coefficient, α_{T}, is 6%/K at room temperature.

The detector signal is then given by

ΔJ_{D}=α_{T}ΔT_{D} (29)

This signal is converted to a voltage by the focal plane read out integrated circuit. It is then read out to provide the data for the tomographic analysis, that is used to create the spectral image data cube and its principal components.

What I claim my invention is:

1. A Long Wavelength Infrared (greater than 8 micrometers ) imaging spectrometer that consists of:
A telescope,
An aperture,
A direct vision prism that allows a center wavelength within its band-pass to pass un-deviated while dispersing shorter wavelengths in one direction and longer wavelengths in the other,
A focus lens, And,
An uncooled thermal imaging sensor or uncooled focal plane array.

1a. An imaging spectrometer described in (1) that:
Does not contain the telescope.

1b. An imaging spectrometer described in (1) that:
Does not contain the aperture.

1c. An imaging spectrometer described in (1) that:
Does not contain the telescope or the aperture.

1d. An imaging spectrometer described in (1) that:
Contains a grating instead of a direct vision prism.

1e. A non-imaging spectrometer described in (1) that:
Contains one or more direct vision prisms or gratings.

1f. A spectrometer described in (1 and 1a-1e) that:
Uses a semiconductor or metallic resistive bolometer array as the imaging sensor.

1g. A spectrometer described in (1 and 1a-1e) that:
Uses a junction diode array or Schottky diode array as the imaging sensor.

1h. A spectrometer described in (1 and 1a-1e) that:
Uses a capacitor array as the imaging sensor.
